(19) United States
(12) Patent Application Publication
(10) Pub. No.: US 2024/0357276 A1
(43) Pub. Date: Oct. 24, 2024

(54) EARPHONE, EARPHONE NOISE REDUCTION MODE SWITCHING METHOD AND DEVICE, AND STORAGE MEDIUM

(71) Applicant: GOERTEK TECHNOLOOGY CO., LTD, Quingdao, Shandong (CN)

(72) Inventor: Chen Huang, Qingdao (CN)

(73) Assignee: GOERTEK TECHNOLOOGY CO., LTD, Quingdao, Shandong (CN)

(21) Appl. No.: 18/688,072

(22) PCT Filed: Dec. 18, 2021
(86) PCT No.: PCT/CN2021/139384

§ 371 Date: Feb. 29, 2024

(30) Foreign Application Priority Data
Aug. 30, 2021 (CN) 202111007034.X

(51) Int. Cl. H04R 1/10; G10K 11/178; H04W 4/02

(52) U.S. Cl. CPC H04R 1/1083; G10K 11/17837; H04W 4/023; H04R 2460/01

(57) ABSTRACT

The present disclosure provides an earphone noise reduction mode switching method applied to a first earphone which is in an active noise reduction mode, and the method comprises: in the event of receiving a first conversation request from a second earphone, switching the active noise reduction mode to an aware mode or a voice enhanced mode; wherein the first conversation request is a request sent to the first earphone after the second earphone establishes a link with the first earphone in the event that the second earphone detects that a second user wearing the second earphone has a conversation demand and the first earphone is a target orientation earphone for the second user.

### CROSS-REFERENCE TO RELATED APPLICATIONS

The present disclosure is a National Stage of International Application PCT/CN2021/139384, which claims priority to a Chinese patent application No. 202111007034.X filed with the CNIPA on Aug. 30, 2021 and entitled “EARPHONE, EARPHONE NOISE REDUCTION MODE SWITCHING METHOD AND DEVICE, AND STORAGE MEDIUM”, both of which are hereby incorporated by reference in their entireties.

### TECHNICAL FIELD

The present disclosure relates to the field of computer application, and particularly to an earphone, an earphone noise reduction mode switching method and device, and a storage medium.

### BACKGROUND

With the progress of science and technology, earphones are becoming more and more popular, bringing a lot of convenience for people's work and life.

Many earphones support a noise reduction mode, such as supporting an active noise reduction mode, an aware mode, a voice enhanced mode, etc. In the active noise reduction mode, an earphone worn by a user can shield the user from external noise. In the aware mode or the voice enhanced mode, the user may still have a normal conversation when wearing the earphone, which can meet the user's voice acquisition needs in work or life scenarios.

At present, the noise reduction mode of the earphone is manually set by the user, and the earphone works according to the noise reduction mode manually set by the user, and when the earphone is in the active noise reduction mode, the user wearing the earphone is less likely to hear outside sounds, and is prone to miss the conversation demands of others, resulting in a poor user experience.

### SUMMARY

An objective of the present disclosure is to provide an earphone, an earphone noise reduction mode switching method and device, and a storage medium, for switching the noise reduction mode automatically and facilitating the user wearing the earphone to respond to a conversation demand of another user, thereby improving the user's experience.

To solve the above technical problem, the present disclosure provides the following technical solutions:

An earphone noise reduction mode switching method, applied to a first earphone which is in an active noise reduction mode, the earphone noise reduction mode switching method comprising:

receiving a first conversation request from a second earphone;

switching the active noise reduction mode to an aware mode or a voice enhanced mode;

wherein the first conversation request is a request sent to the first earphone after the second earphone establishes a link with the first earphone in the event that the second earphone detects that a second user wearing the second earphone has a conversation demand and the first earphone is a target orientation earphone for the second user.

In another embodiment of the present disclosure, before switching the active noise reduction mode to an aware mode or a voice enhanced mode, further comprising:

determining whether a first user wearing the first earphone is a target user of the first conversation request;

if the first user is the target user of the first conversation request, then performing the step of switching the active noise reduction mode to an aware mode or a voice enhanced mode.

In another embodiment of the present disclosure, further comprising:

in the event that the first user is not the target user of the first conversation request, ignoring the first conversation request, or returning a response refusal message to the second earphone.

In another embodiment of the present disclosure, said “determining whether a first user wearing the first earphone is a target user of the first conversation request” comprises:

identifying voice information carried in the first conversation request; and

if the voice information is consistent with the preset switching trigger information, then determining the first user wearing the first earphone to be the target user of the first conversation request.

In another embodiment of the present disclosure, after switching the active noise reduction mode to an aware mode or a voice enhanced mode, the method further comprises:

controlling a sound pickup direction based on an orientation of the second user.

In another embodiment of the present disclosure, the method further comprises:

in the event that it is detected that a first user wearing the first earphone has a conversation demand, establishing a link with a third earphone and sending a second conversation request to the third earphone, such that switching the active noise reduction mode to the aware mode or the voice enhanced mode in the event that the third earphone receives the second conversation request, and the third earphone is a target orientation earphone of the first user in the active noise reduction mode.

In another embodiment of the present disclosure, the target orientation earphone of the first user is determined through the following steps:

detecting a relative angle between each earphone and the first user within a pre-set distance range;

determining an earphone with a relative angle within a pre-set angle range as the target orientation earphone of the first user.

In another embodiment of the present disclosure, further comprising:

in the event that it is detected that the first user has a conversation demand, switching the active noise reduction mode to the aware mode or the voice enhanced mode.

In another embodiment of the present disclosure, after switching the active noise reduction mode to an aware mode or a voice enhanced mode, further comprising:

if the voice information of the first user wearing the first earphone is not detected within a pre-set period of time, then switching the aware mode or the voice enhanced mode to the active noise reduction mode.

In another embodiment of the present disclosure, after receiving a first conversation request from a second earphone and before switching the active noise reduction mode to an aware mode or a voice enhanced mode, further comprising:

determining whether it is currently in a distraction free mode;

if it is not in the distraction free mode, then performing the step of switching the active noise reduction mode to an aware mode or a voice enhanced mode; or

if it is in the distraction free mode, then returning a distraction free response information to the second earphone.

An earphone noise reduction mode switching device, applied to a first earphone which is in an active noise reduction mode, the earphone noise reduction mode switching device comprises:

a conversation request receiving module configured for receiving a first conversation request from a second earphone; and

a noise reduction mode switching module configured for switching the active noise reduction mode to an aware mode or a voice enhanced mode;

wherein the first conversation request is a request sent to the first earphone after the second earphone establishes a link with the first earphone in the event that the second earphone detects that a second user wearing the second earphone has a conversation demand and the first earphone is a target orientation earphone for the second user.

An earphone comprising an earphone body, and a memory as well as a processor which are provided in the earphone body, wherein:

the memory is configured for storing computer program; and

the processor is configured for implementing steps of the earphone noise reduction mode switching method described in any one of the above when executing the computer program.

A computer readable storage medium, the computer readable storage medium stores computer program therein, and the computer program, when executed by a processor, implements steps of the earphone noise reduction mode switching method as described in any one of the above.

By applying the technical solution provided by embodiments of the present disclosure, the first earphone is in an active noise reduction mode, and in the event that the second earphone detects that a second user wearing the second earphone has a conversation demand and the first earphone is a target orientation earphone of the second user, it is possible for the second earphone to establish a link with the first earphone, and send the first conversation demand to the first earphone; and in the event that the first earphone receives the first conversation request from the second earphone, switching the active noise reduction mode to the aware mode or the voice enhanced mode, such that the first user wearing the first earphone can have a normal conversation with the second user wearing the second earphone. In the event that receiving a conversation request and the user wearing the earphone is the target user of the conversation request, the earphone can automatically perform switching from the noise reduction mode, which facilitates the user wearing the earphone to respond to a conversation demand of another user, thereby improving the user's experience.

### BRIEF DESCRIPTION OF THE DRAWINGS

In order to clearly illustrate technical solutions of the embodiments of the present disclosure or those in the prior art, accompanying drawings that need to be used in the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is an implementation flow chart of an earphone noise reduction mode switching method in an embodiment of the present disclosure;

FIG. 2 is a schematic structural illustration of an earphone noise reduction mode switching device in an embodiment of the present disclosure;

FIG. 3 is a schematic structural illustration of an internal construction of an earphone in an embodiment of the present disclosure.

### DETAILED DESCRIPTION

The core of the present disclosure is to provide an earphone noise reduction mode switching method, and the method may be applied to a first earphone which is in an active noise reduction mode. In the event that the second earphone detects that a second user wearing the second earphone has a conversation demand and the first earphone is a target orientation earphone of the second user, it is possible for the second earphone to establish a link with the first earphone, and send the first conversation demand to the first earphone; and in the event that the first earphone receives the first conversation request from the second earphone, switch the active noise reduction mode to the aware mode or the voice enhanced mode, such that the first user wearing the first earphone can have a normal conversation with the second user wearing the second earphone. In the event that receiving a conversation request and the user wearing the earphone is the target user of the conversation request, the earphone can automatically perform switching from the noise reduction mode, which facilitates the user wearing the earphone to respond to a conversation demand of another user, thereby improving the user's experience.'

In order to enable those in the art to better understand the embodiments of the present disclosure, the present disclosure is described in further detail below in connection with the accompanying drawings and specific embodiments. Obviously, the described embodiments are only a part of the embodiments of the present disclosure, and not all of the embodiments. Based on the embodiments in the present disclosure, all other embodiments obtained by a person of ordinary skill in the art without making creative labor fall within the scope of protection of the present disclosure.

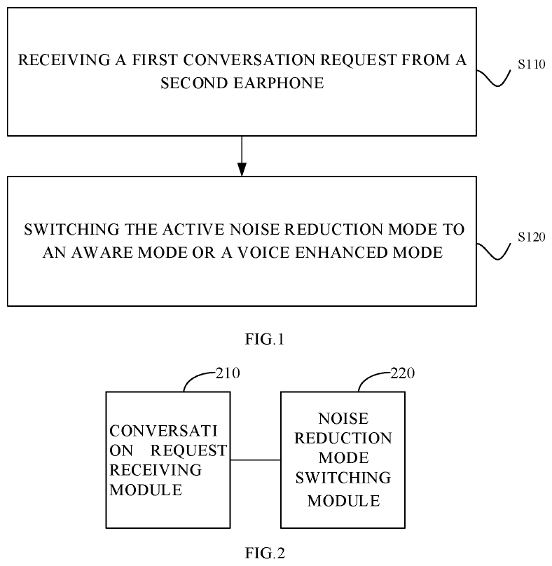

As shown in FIG. 1, it is an implementation flow chart of an earphone noise reduction mode switching method provide by an embodiment of the present disclosure. The method comprises the following steps:

S110: receiving a first conversation request from a second earphone.

Wherein the first conversation request is a request sent to the first earphone after the second earphone establishes a link with the first earphone in the event that the second earphone detects that a second user wearing the second earphone has a conversation demand and the first earphone is a target orientation earphone for the second user. The target orientation earphone of the second user may include earphones facing the second user and other earphones near the second user.

The first earphone is in the active noise reduction mode, which shields the first user wearing the first earphone from external noise.

The second user wearing second earphone may have a conversation demand with the first user. The second earphone may detect whether the second user wearing the second earphone is speaking through a microphone or a VPU (Voice Pick-Up, Bone Voice ID) sensor. If the second user is speaking, it can be determined that the second user has the conversation demand. Or, when it is detected that the second user is speaking, then what is further to be identified is whether the content spoken by the second user is a person's name. If what is identified is person's name, then it can be considered that the second user has the conversation demand. Or, if what is identified is person's name, then it can be further determined whether the second user has the conversation demand based on the second user's address book and/or their location.

For example, if the identified person's name is in the second user's address book, then it can be considered that the second user has a conversation demand, or it is determined that the second user is in the company according to the location of the second user. If the identified person's name is noted as a colleague or in a colleague group in the second user's address book, it can be considered that the second user has the conversation demand. Otherwise, if the second user is in the company, but the identified person's name is noted as a friend or in a friend group in the second user's address book, it can be considered that the second user has no conversation demand.

When the second earphone detects that a second user wearing the second earphone has a conversation demand, it can be further determined that whether the first earphone is the target orientation earphone for the second user. Specifically, it is possible to detect a relative angle between each earphone and the second user within a pre-set distance range, and determine an earphone with a relative angle within a pre-set angle range as the target orientation earphone for the second user.

Specifically, the second earphone may use supported communication protocols, such as Bluetooth, to scan LE Audio (Low Energy Audio) devices within a pre-set distance. If it can be scanned, the relative angle between each earphone and the second user within a pre-set distance range can be detected by Bluetooth AOA (Angle-of-Arrival) technology, and it can be determined which earphone is in front of the second user according to the relative angle. It can be considered that the second user is more likely to have conversation demand with the user wearing the earphone in front of him. It is possible to determine the earphone with the relative angle within a pre-set angle range as the target orientation earphone of the second user, and the first earphone may be any one of the earphones in the target orientation earphone for the second user.

The distance range and the angle range can be set and adjusted according to the actual situation, which is not limited by the embodiment of the present disclosure.

In the event that the second earphone detects that a second user wearing the second earphone has a conversation demand and the first earphone is a target orientation earphone of the second user, it is possible for the second earphone to establish a link with the first earphone, such as establishing a LE Audio link, and send the first conversation request to the first earphone through the link. The first conversation request may carry the voice information of the second user.

The first earphone can continue with step S120 if it receives the first conversation request from the second earphone.

S120: switching the active noise reduction mode to an aware mode or a voice enhanced mode.

In the embodiment of the present disclosure, in the event that the first earphone receives the first conversation request from the second earphone, it is possible to switch its active noise reduction mode to the aware mode or the voice enhanced mode, such that the first user may also have a normal conversation with the second user while wearing the first earphone.

By applying the method provided by the embodiment of the present disclosure, the first earphone is in the active noise reduction mode, and in the event that the second earphone detects that a second user wearing the second earphone has a conversation demand and the first earphone is a target orientation earphone of the second user, it is possible for the second earphone to establish a link with the first earphone, and send the first conversation demand to the first earphone; and in the event that the first earphone receives the first conversation request from the second earphone, switching the active noise reduction mode to the aware mode or the voice enhanced mode, such that the first user wearing the first earphone can have a normal conversation with the second user wearing the second earphone. In the event that receiving a conversation request and the user wearing the earphone is the target user of the conversation request, the earphone can automatically perform switching from the noise reduction mode, which facilitates the user wearing the earphone to respond to a conversation demand of another user, thereby improving the user's experience.

In one embodiment of the present disclosure, before switching the active noise reduction mode to an aware mode or a voice enhanced mode in the step S120, the method may further comprise the following steps:

determining whether a first user wearing the first earphone is a target user of the first conversation request; and

if the first user is the target user of the first conversation request, then performing the step of switching the active noise reduction mode to an aware mode or a voice enhanced mode.

It can be understood that the first earphone receives the first conversation request from the second earphone, thus it can be considered that there is a conversation demand at present, but it is uncertain whether the corresponding user is the conversation target user. In order to avoid unnecessary switching and thus improve switching accuracy, the first earphone may first determine whether the first user wearing the first earphone is the target user of the first conversation request before switching the active noise reduction mode to the aware mode or the voice enhanced mode. Specifically, the first earphone may determine whether the first user is the target user of the first conversation request according to the voice information carried in the first conversation request.

In the event that the first user is determined to be the target user of the first conversation request, the first earphone then executes the step of switching the active noise reduction mode to the aware mode or the voice enhanced mode, thereby improving the switching accuracy.

In one embodiment of the present disclosure, the method may further comprise the following steps:

in the event that the first user is not the target user of the first conversation request, ignoring the first conversation request, or returning a response refusal message to the second earphone.

In the embodiment of the present disclosure, the first earphone is in the active noise reduction mode, which shields the first user wearing the first earphone from outside noise. If the first earphone can receive the first conversation request sent from the second earphone, it can be considered that the first earphone is the target orientation earphone of the second user wearing the second earphone, and the second user is more likely to have conversation demand with the first user wearing the first earphone. However, it cannot be directly determined that the first user is the target user of first conversation request.

In the event that the first user wearing the first earphone is determined not to be the target user of the first conversation request, the first earphone may ignore the first conversation request and make no response. Or, it is possible to return a response refusal message to the second earphone, such that the second earphone prompts the second user that there is currently a response refusal message from the first earphone through voice, sound and light, etc., and the second user can take appropriate measures according to the actual situation.

When the first user is not the target user of the first conversation request, the first earphone ignores the first conversation request, or returns a response refusal message to the second earphone, does not perform switching operation of the noise reduction mode, and can continuously shield the external noise for the first user wearing the first earphone, thereby providing noise reduction service for the first user.

It should be noted that if the first earphone cannot identify the first conversation request when receiving the first conversation request from the second earphone, then ignore the first conversation request, or return a response refusal message to the second earphone.

In one embodiment of the present disclosure, determining whether a first user wearing the first earphone is a target user of the first conversation request, may comprise the following steps:

Step one: identifying voice information carried in the first conversation request; and

Step two: if the voice information is consistent with the preset switching trigger information, then determining the first user wearing the first earphone to be the target user of the first conversation request.

For the convenience of description, the above two steps are described in combination.

In the embodiment of the present disclosure, the first user wearing first earphone can preset switching trigger information in the first earphone, for example, the common name of the first user is set as the switching trigger information.

When the second earphone sends the first conversation request to the first earphone, it is possible to carry the voice information of the second user in the first conversation request, such as the name of the person spoken by the second user. The first earphone may identify the voice information carried in the first conversation request after receiving the first conversation request of the second earphone, and compare the identified voice information with the preset switching trigger information.

If the identified voice information is consistent with the preset switching trigger information, then determining the first user wearing the first earphone to be the target user of the first conversation request; on the contrary, if the identified voice information is inconsistent with the preset switching trigger information, then determining the first user wearing the first earphone not to be the target user of the first conversation request. In this way, it is possible to more accurately determine whether the first user is the target user of the first conversation request, so that the switching operation is not performed when the first user is not the target user of the first conversation request, thereby avoiding unnecessary switching and refraining from affecting the use of the earphone of the first user.

In one embodiment of the present disclosure, after switching the active noise reduction mode to an aware mode or a voice enhanced mode, the method may further comprise the following steps:

controlling a sound pickup direction based on an orientation of the second user.

In the embodiment of the present disclosure, in the event that the first earphone receives the first conversation request of the second earphone and the first user wearing the first earphone is determined to be the subject user of the first conversation request, after switching the active noise reduction mode to an aware mode or a voice enhanced mode, it is also possible to control the sound pickup direction based on the orientation of the second user, for example, it is possible to control the sound pickup direction by combining voiceprint recognition and beam forming, sound source separation and other techniques, so as to better pick up the voice of the second user. The first earphone may determine the orientation of the second user through positioning technologies.

In one embodiment of the present disclosure, the method may further comprise the following steps:

in the event that it is detected that a first user wearing the first earphone has a conversation demand, establishing a link with a third earphone and sending a second conversation request to the third earphone, such that switching the active noise reduction mode to the aware mode or the voice enhanced mode in the event that the third earphone receives the second conversation request, and the third earphone is a target orientation earphone of the first user in the active noise reduction mode.

In the embodiment of the present disclosure, the first user wearing the first earphone may have a conversation demand with other users. The first earphone may detect whether the first user wearing the first earphone is speaking through a microphone or a VPU sensor. If the first user is speaking, it may be determined that the first user has a conversation demand. Or, upon detecting that the first user is speaking, it is further identified whether the content spoken by the first user is a person's name, and if it is identified as the person's name, it can be considered that the first user has the conversation demand. Or, if it is identified as the person's name, it can be further determined that whether the first user has the conversation demand based on the address book and/or its location of the first user.

For example, if the identified person's name is in the address book of the first user, it can be considered that first user has the conversation demand; or when it is determined that the first user is in the company according to the location of the first user, then it can be considered that the first user has the conversation demand if the identified person's name is noted as a colleague in the first user's address book or in a colleague group; on the contrary, if the first user is in the company but the identified person's name is noted as friend/family in the first user's address book or in the friend/family group, then it can be considered that the first user has no conversation demand.

When the first earphone detects that the first user wearing the first earphone has the conversation demand, it may further determine the target orientation earphone of the first user. Specifically, it is possible to detect a relative angle between each earphone and the first user within a pre-set distance range, and determine an earphone with a relative angle within a pre-set angle range as the target orientation earphone of the first user.

Specifically, the first earphone may use supported communication protocols, such as Bluetooth, to scan LE Audio devices within a pre-set distance. If it can be scanned, the relative angle between each earphone and the first user within a pre-set distance range can be detected by Bluetooth AOA technology, and it can be determined which earphone is in front of the first user according to the relative angle. It can be considered that the first user is more likely to have conversation demand with the user wearing the earphone in front of him. It is possible to determine the earphone with the relative angle within a pre-set angle range as the target orientation earphone of the first user. The target orientation earphone of the first user may be one or more, and the third earphone is any one of the target orientation earphone of the first user and is in the active noise reduction mode.

The distance range and the angle range can be set and adjusted according to the actual situation, which is not limited by the embodiment of the present disclosure.

In the event that the first earphone detects that a first user wearing the first earphone has a conversation demand and the third earphone is a target orientation earphone of the first user, it is possible for the second earphone to establish a link with the third earphone, such as establishing a LE Audio link, and send the second conversation request to the third earphone through the link. The second conversation request may carry the voice information of the first user.

In the event that the third earphone receives the second conversation request from the first earphone, it can be considered that there is a conversation demand currently, and the active noise reduction mode may be switched as the aware mode or the voice enhanced mode, such that the third use may have a normal conversation with the first user when wearing the third earphone. Or, in the event that the third earphone receives the second conversation request of the first earphone and determine the third user wearing the third earphone as the target user of the second conversation request, switching the active noise reduction mode to the aware mode or the voice enhanced mode, so as to improve switching accuracy.

For the third earphone how to determine whether the third user is the target user of the second conversation request, how to operate when determining that the third user is not the target user of the second conversation request, how to control the sound pickup direction, etc., please refer to processing way of the first earphone, which is not repeated herein.

In one embodiment of the present disclosure, in the event that the first earphone detects that the first user has a conversation demand, the active noise reduction mode may be switched to the aware mode or the voice enhanced mode, so as to facilitate the first user to converse with other users.

In one embodiment of the present disclosure, after switching the active noise reduction mode to an aware mode or a voice enhanced mode, there may be additionally the following step:

if the voice information of the first user wearing the first earphone is not detected within a pre-set period of time, then switching the aware mode or the voice enhanced mode to the active noise reduction mode.

After the first earphone switched the active noise reduction mode to the aware mode or the voice enhanced mode, it is possible to facilitate the first user wearing the first earphone to converse with other users. It could be understood that the conversation between users is a process of interaction under a normal circumstance. If the voice information of the first user is not detected within a pre-set period of time, it can be considered that the conversation between the first user and other users has ended, and then the aware mode or the voice enhanced mode may be switched to the active noise reduction mode, thereby shielding the first user from external noise.

In one embodiment of the present disclosure, after receiving a first conversation request from a second earphone and before switching the active noise reduction mode to an aware mode or a voice enhanced mode, the method may further comprise the following steps:

Step one: determining whether it is currently in a distraction free mode; if it is not in the distraction free mode, then performing the step of switching the active noise reduction mode to an aware mode or a voice enhanced mode; if it is in the distraction free mode, then performing the operation of step two;

returning a distraction free response information to the second earphone.

For the convenience of description, the above steps are described in combination.

In the event that the first earphone receives the first conversation request from the second earphone, it is possible to first determine whether the first earphone is in the distraction free mode. If it is in the distraction free mode, then it can be considered that the current first user does not wish to be disturbed. In this case, the first earphone may return a distraction free response information to the second earphone, such as returning a corresponding distraction free response information by voice or signal light, etc. If it is not in the distraction free mode, then the active noise reduction mode may be switched to the aware mode or the voice enhanced mode.

Determining whether it is currently in the distraction free mode before performing the determination of switching the noise reduction mode, so as to better fit the actual needs of the user.

In response to the method embodiments above, an embodiment of the present disclosure also provide an earphone noise reduction mode switching device applied to a first earphone which is in an active noise reduction mode.

The earphone noise reduction mode switching device described below and the earphone noise reduction mode switching method described above can refer to each other.

As shown in FIG. 2, the device may comprise the following modules:

a conversation request receiving module 210 configured for receiving a first conversation request from a second earphone;

a noise reduction mode switching module 220 configured for switching the active noise reduction mode to an aware mode or a voice enhanced mode;

wherein the first conversation request is a request sent to the first earphone after the second earphone establishes a link with the first earphone in the event that the second earphone detects that a second user wearing the second earphone has a conversation demand and the first earphone is a target orientation earphone for the second user.

By applying the device provided by embodiment of the present disclosure, the first earphone is in an active noise reduction mode, and in the event that the second earphone detects that a second user wearing the second earphone has a conversation demand and the first earphone is a target orientation earphone of the second user, it is possible for the second earphone to establish a link with the first earphone, and send the first conversation demand to the first earphone; and in the event that the first earphone receives the first conversation request from the second earphone, switching the active noise reduction mode to the aware mode or the voice enhanced mode, such that the first user wearing the first earphone can have a normal conversation with the second user wearing the second earphone. In the event that receiving a conversation request and the user wearing the earphone is the target user of the conversation request, the earphone can automatically perform switching from the noise reduction mode, which facilitates the user wearing the earphone to respond to a conversation demand of another user, thereby improving the user's experience.

In one specific implementation of the present disclosure, further comprising a subject user determining module configured for:

before switching the active noise reduction mode to an aware mode or a voice enhanced mode, determining whether a first user wearing the first earphone is a target user of the first conversation request;

if the first user is the target user of the first conversation request, then triggering the noise reduction mode switching module 220 to perform the step of switching the active noise reduction mode to an aware mode or a voice enhanced mode.

In one specific implementation of the present disclosure, further comprising a conversation request refusing module configured for:

in the event that the first user is not the target user of the first conversation request, ignoring the first conversation request, or returning a response refusal message to the second earphone.

In one specific implementation of the present disclosure, the subject user determining module 210 is configured for:

identifying voice information carried in the first conversation request;

if the voice information is consistent with the preset switching trigger information, then determining the first user wearing the first earphone to be the target user of the first conversation request.

In one specific implementation of the present disclosure, further comprising a sound pickup direction controlling module configured for:

after switching the active noise reduction mode to an aware mode or a voice enhanced mode, controlling a sound pickup direction based on an orientation of the second user.

In one specific implementation of the present disclosure, further comprising a conversation request sending module configured for:

in the event that it is detected that a first user wearing the first earphone has a conversation demand, establishing a link with a third earphone and sending a second conversation request to the third earphone, such that switching the active noise reduction mode to the aware mode or the voice enhanced mode in the event that the third earphone receives the second conversation request, and the third earphone is a target orientation earphone of the first user in the active noise reduction mode.

In one specific implementation of the present disclosure, further comprising a target orientation earphone determining module configured for determining a target orientation earphone of the first user by the following steps:

detecting a relative angle between each earphone and the first user within a pre-set distance range;

determining an earphone with a relative angle within a pre-set angle range as the target orientation earphone of the first user.

In one specific implementation of the present disclosure, the noise reduction mode switching module 220 is further configured for:

in the event that it is detected that the first user has a conversation demand, switching the active noise reduction mode to the aware mode or the voice enhanced mode.

In one specific implementation of the present disclosure, the noise reduction mode switching module 220 is further configured for:

after switching the active noise reduction mode to an aware mode or a voice enhanced mode, if the voice information of the first user wearing the first earphone is not detected within a pre-set period of time, then switching the aware mode or the voice enhanced mode to the active noise reduction mode.

In one specific implementation of the present disclosure, further comprising a distraction free processing module configured for:

after receiving a first conversation request from a second earphone and before switching the active noise reduction mode to an aware mode or a voice enhanced mode, determining whether it is currently in a distraction free mode; if it is not in the distraction free mode, then triggering the noise reduction mode switching module 220 to perform the step of switching the active noise reduction mode to an aware mode or a voice enhanced mode; if it is in the distraction free mode, then returning a distraction free response information to the second earphone.

In response to the method embodiments above, an embodiment of the present disclosure also provide an earphone comprising an earphone body, and a memory as well as a processor which are provided in the earphone body, wherein:

the memory is configured for storing a computer program;

the processor is configured for implementing steps of the earphone noise reduction mode switching method described in any one of the above when executing the computer program.

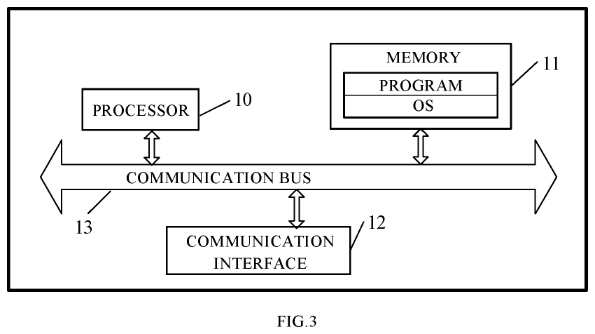

As shown in FIG. 3, it is a schematic structural illustration of an internal construction of an earphone, and the earphone may comprise: a processor 10, a memory 11, a communication interface 12 and a communication bus 13. The processor 10, the memory 11, and the communication interface 12 are communicated with each other through the communication bus 13.

In an embodiment of the present disclosure, the processor 10 may be a Central Processing Unit (CPU), an application specific integrated circuit, a digital signal processor, a field programmable gate array or other programmable logic device, or the like.

The processor 10 may invoke a program stored in the memory 11, and in particular, the processor 10 may perform operations in embodiments of the earphone noise reduction mode switching method.

The memory 11 is configured for storing one or more programs, the programs may include program codes, and the program codes include computer operation instructions. In the embodiment of the present disclosure, the memory 11 at least stores the programs for realizing the following functions:

receiving a first conversation request from a second earphone;

switching the active noise reduction mode to an aware mode or a voice enhanced mode;

wherein the first conversation request is a request sent to the first earphone after the second earphone establishes a link with the first earphone in the event that the second earphone detects that a second user wearing the second earphone has a conversation demand and the first earphone is a target orientation earphone for the second user.

In a possible implementation, the memory 11 may include a program storage area and a data storage area, wherein the program storage area may store an operating system and an application program required for at least one function (such as a mode switching function and an information interaction function); the storage data area may store data created during use, such as noise reduction mode data, conversation request data, and the like.

Further, the memory 11 may include a high-speed random access memory, and may further include a non-volatile memory, such as at least one magnetic disk storage device or other volatile solid state storage device.

The communication interface 12 may be an interface of a communication module for connecting with other devices or systems.

Of course, it should be noted that the structure shown in FIG. 3 does not limit the earphone in the embodiment of the present disclosure, and in practical applications, the earphone may include more or less components than those shown in FIG. 3, or combine some components.

In response to the method embodiments above, an embodiment of the present disclosure also provide a computer readable storage medium, the computer readable storage medium stores computer program therein, and the computer program, when executed by a processor, implements steps of the earphone noise reduction mode switching method described above.

The various embodiments in this specification are described in a progressive manner, and each embodiment focuses on its differences from other embodiments, and the same or similar parts of the various embodiments are referred to each other.

Those skilled in the art will further appreciate that the units and algorithmic steps of the various examples described in conjunction with the embodiments disclosed herein are capable of being implemented in electronic hardware, computer software, or a combination of both, and to clearly illustrate the interchangeability of hardware and software, the composition and steps of the various examples have been described in the foregoing description in general terms according to function. Whether these functions are performed in hardware or software depends on the particular application and design constraints of the technical solution. Those skilled in the art may use different methods to implement the described functions for each particular application, but such implementation should not be considered beyond the scope of the present disclosure.

The steps of the methods or algorithms described in conjunction with the embodiments disclosed herein may be implemented directly with hardware, a software module executed by a processor, or a combination of both. The software module may be placed in random memory (RAM), memory, read-only memory (ROM), electrically programmable ROM, electrically erasable programmable ROM, registers, hard disks, removable disks, CD-ROMs, or any other form of storage medium known in the art.

Specific examples are used herein to illustrate the principles and embodiments of the present disclosure, and the description of the above embodiments is only used to help understand the technical solution and core idea of the present disclosure. It should be noted that those of ordinary skill in the art may make several improvements and modifications to the present disclosure without departing from the principles of the present disclosure, and these improvements and modifications also fall within the scope of the claims of the present disclosure.

1. An earphone noise reduction mode switching method, applied to a first earphone worn by a first user which is in an active noise reduction mode, the method comprising:
receiving a first conversation request from a second earphone; and
switching the active noise reduction mode to an aware mode or a voice enhanced mode;
wherein the first conversation request comprises a request sent to the first earphone after the second earphone establishes a link with the first earphone in the event that the second earphone detects that a second user wearing the second earphone has a conversation demand, and the first earphone comprises a target orientation earphone for the second user.

2. The earphone noise reduction mode switching method according to claim 1, wherein before switching the active noise reduction mode to an aware mode or a voice enhanced mode, the method further comprises:
determining whether the first user wearing the first earphone is a target user of the first conversation request; and
if the first user is the target user of the first conversation request, then performing switching the active noise reduction mode to an aware mode or a voice enhanced mode.

3. The earphone noise reduction mode switching method according to claim 2, further comprising:
in the event that the first user is not the target user of the first conversation request, ignoring the first conversation request, or returning a response refusal message to the second earphone.

4. The earphone noise reduction mode switching method according to claim 2, wherein said determining whether a first user wearing the first earphone is a target user of the first conversation request comprises:
identifying voice information in the first conversation request; and
if the voice information is consistent with preset switching trigger information, then determining the first user wearing the first earphone to be the target user of the first conversation request.

5. The earphone noise reduction mode switching method according to claim 1, wherein after switching the active noise reduction mode to an aware mode or a voice enhanced mode, the method further comprises:
controlling a sound pickup direction based on an orientation of the second user.

6. The earphone noise reduction mode switching method according to claim 1, further comprising:
in the event that a first user wearing the first earphone has a conversation demand, establishing a link with a third earphone and sending a second conversation request to the third earphone, such that the third earphone switches the active noise reduction mode to the aware mode or the voice enhanced mode in the event that the third earphone receives the second conversation request, and the third earphone comprises a target orientation earphone of the first user in the active noise reduction mode.

7. The earphone noise reduction mode switching method according to claim 6, wherein the target orientation earphone of the first user is determined by:
detecting a relative angle between each earphone and the first user within a pre-set distance range; and
determining an earphone with a relative angle within a pre-set angle range as the target orientation earphone of the first user.

8. The earphone noise reduction mode switching method according to claim 6, further comprising:
in the event that the first user has a conversation demand, switching the active noise reduction mode to the aware mode or the voice enhanced mode.

9. The earphone noise reduction mode switching method according to claim 1, wherein after switching the active noise reduction mode to an aware mode or a voice enhanced mode, the method further comprises:
if the voice information of the first user wearing the first earphone is not detected within a pre-set period of time, then switching the aware mode or the voice enhanced mode to the active noise reduction mode.

10. The earphone noise reduction mode switching method according to claim 1, wherein after receiving a first conversation request from a second earphone and before switching the active noise reduction mode to an aware mode or a voice enhanced mode, the method further comprises:
determining whether the first earphone is in a distraction free mode;
if the first earphone is not in the distraction free mode, then performing switching the active noise reduction mode to an aware mode or a voice enhanced mode; or if it is in the distraction free mode, then returning a distraction free response information to the second earphone.

11. An earphone noise reduction mode switching device, applied to a first earphone which is in an active noise reduction mode, the earphone noise reduction mode switching device comprises:
a conversation request receiving module configured for receiving a first conversation request from a second earphone; and
a noise reduction mode switching module configured for switching the active noise reduction mode to an aware mode or a voice enhanced mode;
wherein the first conversation request comprises a request sent to the first earphone after the second earphone establishes a link with the first earphone in the event that the second earphone detects that a second user wearing the second earphone has a conversation demand, and the first earphone comprises a target orientation earphone for the second user.

12. An earphone, comprising an earphone body, a memory, and a processor wherein the memory and processor are provided in the earphone body, and wherein:
the memory is configured for storing computer program; and
the processor is configured for implementing an earphone noise reduction mode switching method according to claim 1 when executing the computer program.

13. A computer readable storage medium, wherein the computer readable storage medium stores computer program therein, and the computer program, when executed by a processor, implements an earphone noise reduction mode switching method according to claim 1.
